(19) United States
(12) Patent Application Publication
(10) Pub. No.: US 2006/0059384 A1
(43) Pub. Date: Mar. 16, 2006

(54) Full backup from incremental /differential backups

(76) Inventor: Fabrice Helliker, Broadstone (GB)

Correspondence Address: MACPHERSON KWOK CHEN & HEID LLP, 1762 TECHNOLOGY DRIVE, SUITE 226, SAN JOSE, CA, 95110, US

(21) Appl. No.: 11/076,322

(22) Filed: Mar. 9, 2005

Related U.S. Application Data
(60) Provisional application No. 60/602,211, filed on Aug. 16, 2004.

(51) Int. Cl. G06F 11/00

(52) U.S. Cl. 714/13

(57) ABSTRACT

A method for backing up data uses at least one previously stored incremental/differential backup to form a full backup. The use of previously stored backups desirably reduces server overhead during the backup process, so that the amount of server resources that can be allocated to other tasks is enhanced.

### PRIORITY CLAIM

This patent application claims the benefit of the priority date of U.S. Provisional Patent Application Ser. No. 60/602,211, filed on Aug. 16, 2004 and entitled FULL BACKUP FROM INCREMENTAL/DIFFERENTIAL BACKUPS (docket no. M-15502-V1 US) pursuant to 35 USC 119, the entire contents of this provisional patent application are hereby expressly incorporated by reference.

### TECHNICAL FIELD

The present invention relates generally to methods and devices for backing up computer files. The present invention relates more particularly to a method and device for performing a full backup in a network environment by using previous incremental/differential backups, so as to reduce server overhead associated with the backup process.

### BACKGROUND

Backup procedures for computers are well known. Backup procedures are performed in order to provide a copy of the data stored on a computer or an associated storage device, so that the data can later be restored in the event that the data is accidentally or maliciously lost.

As those skilled in the art will appreciate, data can be accidentally lost through computer hard disk failures, power losses, fires, floods, earthquakes, and a variety of other unfortunate events. Data can be maliciously lost through erasure, viruses, tampering, and other such intentional events. There is simply no way known at the present to prevent such accidental and malicious loss of data.

However, the loss of data can be mitigated with comparatively little cost and inconvenience by implementing backup procedures to prepare for this eventuality. The use of backup procedures is general far less expensive and inconvenient than the consequences of losing the data. One of the consequences of losing data may be the need to reconstruct the data. Reconstruction of the data is likely to be an undesirably costly and time consuming process.

Frequently, the data cannot be reconstructed. Important information is often permanently lost with severe financial consequences.

Backing up data is merely the process of making an extra copy of the data, so that if the original data is lost or corrupted, the extra copy may be used in its place. This redundancy decreases the likelihood that a single accident or malicious event can make the data permanently unavailable.

Typically, the backed up data is copied to another storage device. This is frequently done over a network. This backup storage device typically has removable media, so that the backed up data can then be easily moved to a remote location. Thus, even in the event of a catastrophe such as a fire or earthquake, the backed up data is not likely to be affected.

Various different systems for performing backups over a network are known. Backups can be made to network attached storage (NAS) devices, storage area networks (SANs) and a variety of other storage devices.

A NAS device is a storage device that is dedicated solely to file sharing. NAS devices typically communicate using transfer control protocol/Internet protocol (TCP/IP) over an Ethernet connection. Although multiple storage devices can be used, NAS systems frequently use a single storage device. A NAS device can add storage capacity to a server without disruption of the system. That is, since a NAS device is not an integral part of a server, there is no need to shut down the system for maintenance or upgrades when adding a NAS device. A NAS device can be located anywhere within a local area network (LAN).

A SAN is a network of shared data storage devices that communicate using Fibre Channel over a small computer systems interface (SCSI). Thus, a SAN has several separate storage devices. A SAN provides simplified storage management, more efficient access to stored data, scalability, and easier backup.

According to contemporary practice, there are three types of backups that are commonly used. These three types are full backups, differential backups, and incremental backups.

Full backups provide a complete copy of all of the data being backed up. Differential and incremental backups only provide a partial copy of the data being backed up and therefore must be used in combination with full backups, if the ability to restore all of the original data is desired.

Since a full backup provides a complete copy of all of the data, a full backup alone is sufficient to provide complete protection. However, full backups are time consuming, computationally intensive, and require more storage space (consume more of the backup media). Therefore, many backup protocols employ periodic full backups in combination with either differential backups or incremental backups so as to mitigate such issues.

A differential backup provides a copy of all of the data that was changed since the last full backup. Each subsequent differential backup performed after the last full backup replaces the previous differential backup. Only one differential backup is required for a restore. Thus, one differential backup plus the last full backup facilitate a complete, up-to-date restore. That is, when differential backups are used, only two backups, i.e., the most recent differential backup and the most recent full backup, are needed for a complete restore.

An incremental backup provides a copy of all of the data that was changed since the previous incremental backup. Thus, all of the incremental backups plus the last full backup facilitate a complete, up-to-date restore. Typically, several incremental backups are required to perform a restore. That is, when incremental backups are used, the number of backups that must be used for a restore depends upon the number of incremental backups that were performed since the last full backup.

Although such contemporary backup methodologies have proven generally suitable for their intended purposes, they possess inherent deficiencies which detract from their overall effectiveness and desirability. For example, regardless of the backup protocol used, according to contemporary practice every full backup is performed by copying all of the data needed from the storage device being backed up.

As those skilled in the art will appreciate, backing up all of the data from a storage device requires substantial computational resources, typically from a server where such computational resources are preferred to be utilized on the routine processes attended to by the server. Even in those instances where the resources of a computer are not required for the backup process, the storage device itself is undesirably tied up during the backup process.

As such, although the prior art has recognized, to a limited extent, the problems associated with backing up data, the proposed solutions have, to date, been ineffective in providing a satisfactory remedy. Therefore, it is desirable to provide a backup method and device which tends to minimize the undesirable use of computer and storage device resources during the backup process. More particularly, it is desirable to provide a backup method and device that minimizes the use of network resources during the backup process.

### BRIEF SUMMARY

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The present invention specifically addresses and alleviates the above mentioned deficiencies associated with the prior art. More particularly, according to one aspect the present invention comprises a method for backing up data, the method comprising using at least one previously stored incremental/differential backup to form a full backup.

As used herein, the term “incremental/differential backup” is defined to include any number of incremental backups in combination with any number of differential backups. Thus, for example, the term includes a single differential backup and also includes a plurality of incremental backups. The term also includes a single differential backup in combination with a plurality of incremental backups, for example. Although incremental and differential backups are different from one another, the terms “incremental” and “differential” may often be used interchangeably herein.

According to one aspect, the present invention comprises a method for backing up data, wherein the method comprises performing at least one incremental/differential backup and using at least one incremental/differential backup to form a full backup. The use of incremental/differential backups to form a full backup tends to mitigate the undesirable use of network resources for the backup process, thus freeing these network resources so that routine network tasks can be more efficiently performed.

The storage device upon which the incremental/differential backups are stored can be off-line when the full backup is formed. In some instances, the incremental/differential backups provide all of the information needed to perform the entire full backup. Thus, the routine activities of the network are not affected.

This is contrary to contemporary practice, wherein the server must provide all of the information necessary to perform the full backup, thus tying up network resources. Indeed, in many instances a server must be completely shut down with respect to its normal activities. Thus, according to the present invention, undesirable disruption of the network is substantially mitigated.

According to one aspect, the present invention comprises a device for backing up data, the device comprising a circuit that is configured to facilitate performance of at least one incremental/differential backup and that is also configured to facilitate the use of at least one incremental/differential backup to form a full backup.

According to one aspect, the present invention comprises a system for backing up data, wherein the system comprises a computer configured to facilitate performance of at least one incremental/differential backup, and wherein the computer is also configured to facilitate the use of at least one incremental/differential backup to form a full backup. The present invention further comprises a storage device for which the incremental/differential backups and the full backup are performed.

According to one aspect, the present invention comprises a computer readable medium upon which is stored a program for backing up data, the program comprising instructions that facilitate performing at least one incremental/differential backup and also facilitate using at least one incremental/differential backup to form a full backup.

According to one aspect, the present invention comprises a data set comprising a full backup that was formed using at least one incremental/differential backup.

According to one aspect, the present invention comprises a method for performing a backup, wherein the method comprises performing at least one incremental/differential backup by monitoring data flow between a device driver and a device.

According to one aspect, the present invention comprises a method for performing a backup, the method comprising flagging changes to stored data that is to be backed up, the flagging being performed at a bit level.

These, as well as other advantages of the present invention, will be more apparent from the following description and drawings. It is understood that changes in the specific structure shown and described may be made within the scope of the claims, without departing from the spirit of the invention.

### BRIEF DESCRIPTION OF THE DRAWINGS

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

FIG. 1 is a flow chart showing a contemporary method for performing backups, wherein a plurality of incremental backups are performed between full backups and the full backups are formed using data from the storage device being backed up; and

FIG. 2 is a flow chart showing an exemplary method for performing backups according to the present invention, wherein a plurality of incremental backups (one or more differential backups may alternatively be used) are performed between full backups and the full backups are formed using data from the incremental backups.

### DETAILED DESCRIPTION OF THE PREFERRED EMBODIMENTS

Many alterations and modifications may be made to the present invention by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more, or different elements, Which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material, or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

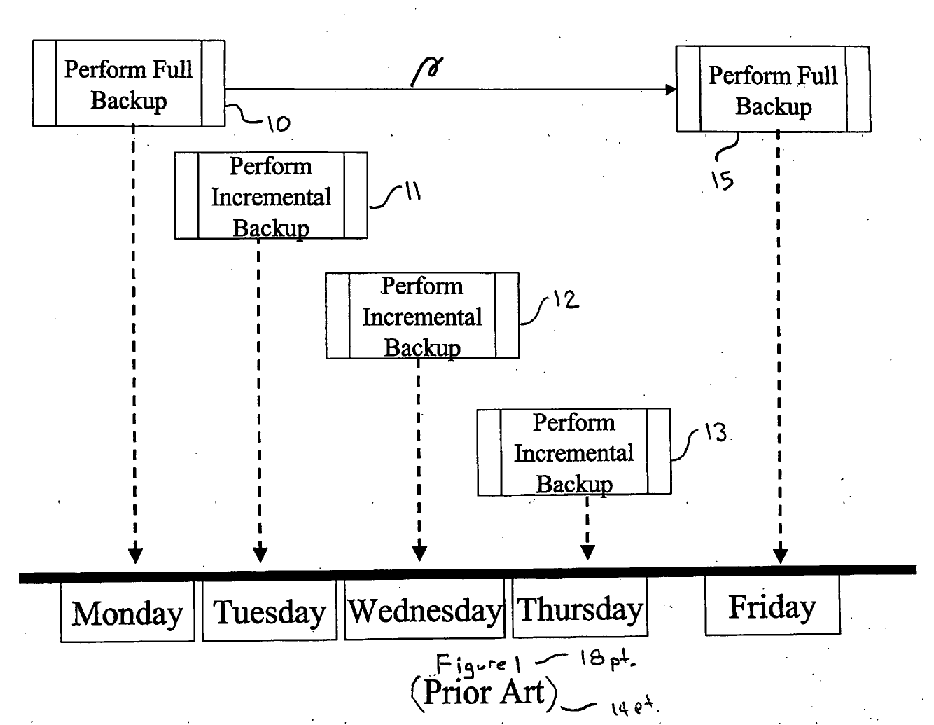

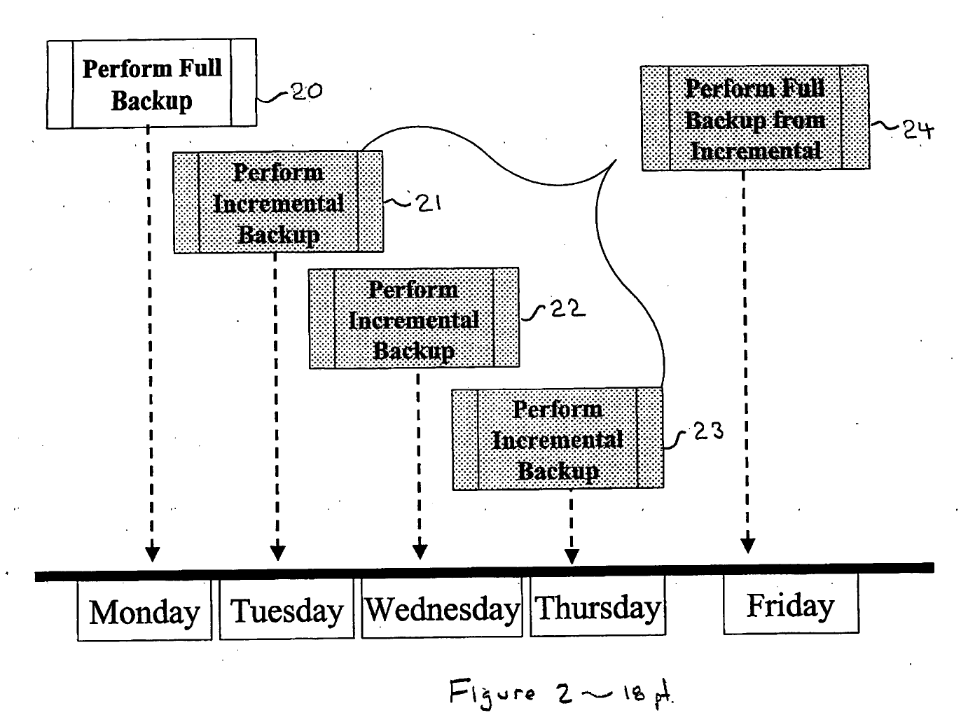

Prior art backup methodology is illustrated in FIG. 1 and an example of backup methodology according to the present invention is illustrated in FIG. 2, which depicts a presently preferred embodiment thereof.

Referring now to FIG. 1, an example of the use of incremental backups according to contemporary practice is shown. A full backup 10 is performed on one day, such as on Monday. Successive incremental backups 11-13 are performed on each of the following three days. Another full backup 15 is performed after the incremental backups 11-13, such as on Friday. This process repeats indefinitely.

The time between successive full backups and the frequency with which incremental/differential backup occur can vary considerably from one facility to another. These parameters depend somewhat on the importance of the data, how frequently the data changes, the volume of the data, the effort required to do the backups, the expense of doing the backups, and the amount of disruption to the routine processes of the computer system caused by the backup process.

As used herein, routine processes are defined as those processes other than the backup process that the computer is commonly used to accomplish. For example, the computer may be used to store sales and inventory records in a database, to serve web pages, and/or to provide word processing services.

Of course, the more important the data is, the more frequently both the full and incremental/differential backups should be preformed. Similarly, the more frequently the data changes, the more frequently it should be backed up.

If there is a large volume of data to be backed up, there is occasionally a tendency to perform backups less often, unless the backup process is automated. Automating the backup process substantially reduces the effort required to perform a backup, but also increases the expense associated therewith, at least initially.

If the ongoing expense of performing backups is high, such as when a large volume of data must be backed up or when the media is expensive, there may be a tendency to perform less frequent backups.

The routine processes of the computer system are often disrupted when a backup is in progress. This disruption occurs because computer resources must generally be allocated to the backup process. Allocation of resources to the backup process inherently leaves less of the resources available for routine processes. Even when a stand alone storage device (one that is not dedicated to a particular computer) is being backed up, the availability of the resources of that storage device for routine processes is undesirably reduced.

The present invention tends to overcome some of the above listed reasons for not doing backups as often as they should be done. More particularly, the present invention most specifically addresses the problem of undesirable disruption of computer resources during the backup process.

Referring now to FIG. 2, the present invention minimizes undesirable disruption of the routine processes of a computer. This is particularly beneficial in network environments, where the present invention minimizes undesirable disruption of the network due to the use of network resources for performance of backup functions. This aspect of the present invention inherently enhances the usefulness of the network. It also tends to desirably facilitate the performance of more frequent backups.

According to one aspect, the present invention comprises a method for backing up data, wherein the method comprises using at least one previously stored incremental/differential backup to form a full backup. As those skilled in the art will appreciate, using previously stored incremental/differential backups reduces the computational load on the computer, which is typically a server, for which the backup is being performed. This, of course, desirably frees the server to perform its other tasks, such as file serving over a network.

When previously stored incremental/differential backups are used to form a new full backup, the storage device upon which the previously stored incremental/differential backups are stored does not necessarily have to be online. That is, this storage device does not necessarily have to be in communication with the network. Thus, undesirable disruption of the network is mitigated.

In some instances, all of the information need to perform the full backup is available in the incremental/differential backups. When this is true, the server that is being backed up does not have to be interrupted in order to perform the backup. Indeed, the network may not even have to be utilized since all of the information needed to perform the full backup is then available from a backup storage device, such as the backup storage device to which the full backup itself is being stored.

When a standalone storage device is being backed up, using previously stored incremental/differential backups reduces the load on the standalone storage device, freeing it up to perform routine storage and retrieval tasks, such as file serving over a network.

Thus, according to the present invention at least one, preferably a plurality, of incremental/differential backups are performed. Then, a full backup is performed. The data set of the full backup comprises data from the incremental/differential backup(s), as well as data from the storage device of the computer being backed up (data that is not in the current incremental/differential backups).

According to the present invention, full backups are formed from both prior incremental/differential backups and from the data storage device, rather than solely from the data storage devices as is done in contemporary practice.

When large databases, spreadsheets, or other data intensive (as opposed to application intensive) storage devices are being backed up according to the present invention, a substantial portion of the data that comprises the full backup is likely to be contained in the incremental/differential backups. Thus, use of the incremental/differential backups to form the full backup is likely to result in freeing up a substantial amount of the computational resources of the computer being backed up.

The incremental/differential backups may performed on a block level. That is, the smallest unit of data that is backed up is a block of data. A block of data is defined herein as a plurality of bits of data. The bock may be of any desired size. Typically, a block of data comprises the smallest unit of data that the operating system of the computer being backed up is capable of reading from the storage device and is thus generally synonymous with a cluster when discussing disk drives. In the NTFS filing system used by Windows, a block of data or cluster is typically 4 KB (although other sizes are possible).

One advantage to performing incremental/differential backups on a block level is that the backup software is more heterogeneous. That is, the backup software is more storage device independent, since the backup software does not have to work on a bit level with respect to the storage device.

The changes to the stored data are flagged on a block level to facilitate incremental/differential backups. That is, any block of data that has changed since the last full backup is flagged to indicate that this block must be part of any upcoming incremental/differential backup.

When incremental/differential backups are performed on a block level, then monitoring of data flow between an operating system and a device driver is performed in order to determine which blocks of data have changed and therefore need to be included in the next incremental/differential backup.

Alternatively, the incremental/differential backups are performed on a bit level. In this manner, the size of the incremental/differential backup may be substantially reduced, since all of the data of a block does not have to be stored as part of an incremental/differential backup. This substantially reduces the time required to perform an incremental/differential backup, the computer or storage device resources needed to perform the backup, and the amount of storage space needed for the backed up data.

When changes to the stored data are flagged on a bit level to facilitate incremental/differential backups, any bit of data that has changed since the last full backup is flagged to indicated that this bit must be part of any upcoming incremental/differential backup. Flagging on a bit level is facilitated by monitoring data changes between the storage device driver and the storage device itself, rather than between the operating system and the storage device.

A first or preliminary full backup is performed prior to performing the first iteration of incremental/differential backups. Since no incremental/differential backups are available at this time, the preliminary full backup is performed without using any incremental/differential backups. That is, the preliminary full backup is performed in the contemporary manner, using only data from the storage device being backed up.

According to the present invention, subsequent full backups are performed by incorporating incremental/differential backups into the full backup. That is, subsequent full backups use data from the incremental/differential backups that have been performed since the last full backup.

Data that is not in the incremental/differential backups is obtained for the full backup by copying the data from the storage device being backed up. Thus, the server of the system being backed up is only used for a portion of the full backup process, rather than for the entire full backup process, as is done according to contemporary methodology.

Alternatively, rather than using data from the device being backed up, data from a previous full backup may be used along with data from the incremental/differential backups to form a new full backup.

That is, either a combination of data from incremental/differential backups and data from the storage device or a combination of data from incremental/differential backups and data from a previous full backup may be used to form the next full backup.

At least one full backup, preferably a plurality of full backups, are performed using the incremental/differential backups in this manner. Optionally, a full backup may be made periodically without using the incremental/differential backups, if desired.

The full backup and the incremental/differential backups may be stored on CD, DVD, a hard drive, tape, or any other desired medium. The backup storage device may be located near the computer being backed up or may be located remotely with respect thereto.

Although reference is occasionally made herein to a computer being backed up, those skilled in the art will appreciate that it is generally a specific storage device that is being backed up and that the storage device may be associated with a particular computer, or may be associated with a plurality of different computers. Further, in some instances it may be desirable to back up a plurality of separate storage devices that define a storage system, such as a RAID (redundant array of inexpensive drives) array. A computer, server, single storage device, or plurality of storage devices may be referred to generically herein as a storage device.

According to one aspect of the present invention, a device for backing up data comprises a circuit configured to facilitate the performance of at least one full backup using at least one incremental/differential backup to form the full backup. The circuit may be defined, at least partially, by a general purpose computer.

According to one aspect of the present invention, a system for backing up data comprises a computer configured to facilitate performance of at least one incremental/differential backup and also configured to facilitate the use of at least one incremental/differential backup to form a full backup. The system also comprises a storage device upon which the incremental/differential backups and the full backup are performed.

According to one aspect of the present invention, a computer readable medium has stored thereon a program for backing up data, wherein the program comprises instructions that facilitate performing at least one incremental/differential backup and using at least one incremental/differential backup to form a full backup.

According to one aspect of the present invention, a data set comprises a full backup that was formed using at least one incremental/differential backup.

According to one aspect of the present invention, a method for performing a backup comprises performing at least one incremental/differential backup by monitoring data flow between a device driver and a device.

According to one aspect of the present invention, a method for performing a backup comprises flagging changes to stored data to be backed up, wherein the flagging is performed at a bit level.

In operation, the backup system of the present invention is configured to perform a preliminary full backup from a storage device. The backup system is configured to then perform a desired number of incremental/differential backups. The backup system is configured to perform another full backup after the desired number of incremental backups have been accomplished by using the incremental/differential backup(s) to form the full backup. The storage device itself is also used to form the full backup, as needed.

The process of performing incremental/differential backups and then full backups using the incremental/differential backups is repeated as long as desired. Then, another full backup may be performed using only the storage device rather than using the incremental/differential backups, if desired.

It is important to appreciate that a single differential backup may alternatively be used in place of at least some of the incremental backups according to the present invention. A differential backup is thus generally equivalent to a plurality of incremental backups for the purposes of the present invention.

It is understood that the exemplary method for performing backups described herein and shown in the drawings represents only presently preferred embodiments of the invention. Indeed, various modifications and additions may be made to such embodiments without departing from the spirit and scope of the invention. For example, any desired number or combination of incremental and/or differential backups may be used to form a full backup according to the present invention. Thus, for example, one differential backup and several incremental backups may be used to form a full backup.

Thus, these and other modifications and additions may be obvious to those skilled in the art and may be implemented to adapt the present invention for use in a variety of different applications.

The present invention provides a backup method and device which tends to minimize the undesirable use of computer and storage device resources during the backup process. More particularly, the present invention provides a backup method and device that desirably minimizes the use of network resources during the backup process.

1. A method for backing up data, the method comprising using at least one previously stored incremental/differential backup to form a full backup.

2. A method for backing up data, the method comprising:
performing at least one incremental/differential backup; and
using at least one incremental/differential backup to form a full backup.

3. The method as recited in claim 2, wherein the previously stored incremental/differential backup(s) are performed on a block level.

4. The method as recited in claim 2, wherein changes to stored data are flagged on a block level to facilitate incremental/differential backups.

5. The method as recited in claim 2, wherein the previously stored incremental/differential backup(s) are performed on a bit level.

6. The method as recited in claim 2, wherein changes to stored data are flagged on a bit level to facilitate incremental/differential backups.

7. The method as recited in claim 2, wherein performing at least one incremental/differential backup comprises monitoring data flow between a device driver and a device.

8. The method as recited in claim 2, wherein performing at least one incremental/differential backup comprises monitoring data flow between an operating system and a device driver.

9. The method as recited in claim 2, further comprising performing a full backup prior to performing the incremental/differential backup(s).

10. The method as recited in claim 2, further comprising performing a preliminary full backup prior to performing the incremental/differential backup(s), the preliminary full backup not using any incremental/differential backups.

11. The method as recited in claim 2, wherein the full backup is performed by backing up data that is not in the incremental/differential backup(s) by copying the data from a storage device being backed up.

12. The method as recited in claim 2, wherein the full backup is performed by backing up data that is not in the incremental/differential backup(s) by copying the data from a previous full backup.

13. The method as recited in claim 2, wherein the full backup and the incremental/differential backup(s) are stored on tape.

14. A device for backing up data, the device comprising a circuit configured to facilitate performance of at least one incremental/differential backup and also configured to facilitate the use of at least one incremental/differential backup to form a full backup.

15. The device as recited in claim 14, wherein the circuit is defined, at least partially, by a general purpose computer.

16. A system for backing up data, the system comprising:
a computer configured to facilitate, performance of at least one incremental/differential backup and also configured to facilitate the use of at least one incremental/differential backup to form a full backup; and
a storage device upon which the incremental/differential backup(s) and the full backup are performed.

17. A computer readable medium upon which is stored a program for backing up data, the program comprising instructions that facilitate performing at least one incremental/differential backup and using at least one incremental/differential backup to form a full backup.

18. A data set comprising a full backup that was formed using at least one incremental/differential backup.

19. A method for performing a backup, the method comprising performing at least one incremental/differential backup by monitoring data flow between a device driver and a device.

20. A method for performing a backup, the method comprising flagging changes to stored data to be backed up, the flagging being performed at a bit level.
